(19) United States
(12) Patent Application Publication
(10) Pub. No.: US 2011/0080539 A1
(43) Pub. Date: Apr. 7, 2011

(54) ILLUMINATION DEVICE AND LIQUID CRYSTAL DISPLAY DEVICE

(75) Inventor: Masaki Shimizu, Osaka-shi (JP)

(73) Assignee: SHARP KABUSHIKI KAISHA, Osaka-shi, Osaka (JP)

(21) Appl. No.: 12/995,735

(22) PCT Filed: Apr. 22, 2009
(86) PCT No.: PCT/JP2009/057986

§ 371 Date: Dec. 2, 2010

(30) Foreign Application Priority Data
Jun. 5, 2008 (JP) 2008-147931

(51) Int. Cl. G02F 1/13357; G02F 1/1335

(52) U.S. Cl. 349/62; 362/97.1

(57) ABSTRACT

A backlight device (20) is disclosed which includes regularly provided light guide plates (40a, 40b, and 40c), the backlight device (20) being arranged such that (i) the light guide plates (40a, 40b, and 40c) have their respective light-emitting surfaces (32a, 32b, and 32c) and light-entering surfaces (34a, 34b, and 34c) via which light from light sources enters the light guide plates (40a, 40b, and 40c), (ii) the light guide plates (40a, 40b, and 40c) are provided so that a first light guide plate (40a) overlaps a second light guide plate (40b) adjacent to the first light guide plate (40a), and (iii) a distance between a light-entering surface (34b) and a light-emitting surface (32b) of the second light guide plate (40b) is different from a distance between a light-entering surface (34a) and a light-emitting surface (32a) of the first light guide plate (40a). As a result, it is possible to provide an illumination device in which an increase in the number of components can be prevented.

### TECHNICAL FIELD

The present invention relates to (i) an illumination device for use as, for example, a backlight device in a liquid crystal display device and (ii) a liquid crystal display device including the illumination device.

### BACKGROUND ART

In recent years, liquid crystal display devices have become popular rapidly in place of cathode ray tube (CRT) based display devices. The liquid crystal display devices have been in widespread use in, for example, liquid crystal televisions, monitors, and mobile phones, all of which take advantage of such features of the liquid crystal display devices as energy saving and being thin and light. One way to further take advantage of such features is to make improvements to an illumination device, that is, a backlight device, which is provided in the back of a liquid crystal display device.

Illumination devices are roughly classified into two types: a side-light type (also referred to as “edge-light type”) and a direct type.

A side-light type illumination device is configured such that (i) a light guide plate is provided behind a liquid crystal display panel and (ii) a light source is provided at a lateral edge of the light guide plate. Light emitted from the light source is reflected in the light guide plate, and thus irradiates the liquid crystal display panel indirectly and uniformly. This configuration makes it possible to produce an illumination device which, although low in luminance, has a reduced thickness and an excellent luminance uniformity. Side-light type illumination devices are thus used mainly in small- to mid-size liquid crystal displays in such devices as mobile phones and laptop personal computers.

A direct type illumination device is provided with a plurality of light sources, aligned behind a liquid crystal display panel, so as to directly irradiate the liquid crystal display panel. Thus, a direct type illumination device can easily achieve a high luminance even in a case where a screen is large. On this account, direct type illumination devices are used mainly in large liquid crystal displays measuring 20 inches or more. Direct type illumination devices which are currently available, however, have a thickness of as much as approximately 20 mm to approximately 40 mm. This prevents a further reduction in the thickness of the displays.

Such a further reduction in the thickness of a large liquid crystal display can be achieved by reducing a distance between (i) the light sources and (ii) the liquid crystal display panel. In this case, however, it is impossible to achieve uniformity in luminance of the illumination device without increasing the number of light sources. Increasing the number of light sources, at the same time, results in an increased cost. This gives rise to a need for developing, without increasing the number of light sources, an illumination device which has a reduced thickness and an excellent luminance uniformity.

Conventionally, in order to solve these problems, such an attempt has been conducted that (i) a plurality of side-light type illumination devices are aligned and (ii) the thickness of the large liquid crystal display is thereby reduced.

Patent Literature 1 discloses an example of a side-light type illumination device. Specifically, Patent Literature 1 discloses an arrangement in which (i) a light guide plate is divided into blocks, and (ii) a group of LEDs (light-emitting diodes) are provided along an end section of each block. This arrangement allows control of causing each block to be turned on and off individually.

Further, Patent Literature 2 discloses an arrangement in which an LED array, including LEDs aligned in an array on a printed circuit board, is provided at an end of each light guide plate.

### CITATION LIST

### Patent Literature 1

U.S. Patent Application No. 2007/0247871, Specification (Publication Date: Oct. 25, 2007)

### Patent Literature 2

Japanese Patent Application Publication, Tokukai, No. 2006-286638 A (Publication Date: Oct. 19, 2006)

### SUMMARY OF INVENTION

The above conventional illumination devices are, however, problematic in that the number of components is large.

Specifically, an illumination device which is driven with use of a plurality of light guide plates aligned requires one LED unit, as a light source, for each light guide plate so that light emitted from a light source reliably enters each light guide plate. For example, the arrangement disclosed in Patent Literature 2 uses one LED array for each light guide plate.

In a case where, for example, an illumination device having the above arrangement is included as a backlight device in a liquid crystal display device having a large display screen, the number of components increases more problematically. Specifically, such a large display screen requires more light guide plates and consequently more LED arrays. This leads to an increase in the number of components.

Such an increase in the number of components may reduce efficiency of illumination device production.

Further, the increase in the number of components may also unnecessarily increase a total area occupied by LED substrates (the LED arrays) mounted in a backlight device serving as an illumination device.

In addition, since an LED substrate is normally expensive as a component to be mounted, an increase in the number of LED substrates may prevent a reduction in cost of a backlight device.

The present invention has been accomplished in view of the above problems. It is an object of the present invention to provide an illumination device and a liquid crystal display device in each of which an increase in the number of components can be prevented.

It is another object of the present invention to provide an illumination device and a liquid crystal display device in each of which (i) an increase in thickness of the illumination device is prevented, (ii) an increase in size of a substrate on which light sources are mounted is prevented, and (iii) light emitted from a light source can be reliably guided to a light-emitting surface.

In order to solve the above problems, an illumination device of the present invention includes: light sources; and a plurality of light guide plates each of which causes surface emission of light emitted from a corresponding one of the light sources, the plurality of light guide plates being regularly provided, each of the plurality of light guide plates having (i) a light-emitting surface via which the surface emission of the light is caused, and (ii) a light-entering surface via which the light emitted from the corresponding one of the light sources enters said each of the plurality of light guide plates, the plurality of light guide plates being provided so that a first one of any adjacent two of the plurality of light guide plates overlaps a second one of said any adjacent two of the plurality of light guide plates, a first distance between a light-entering surface and a light-emitting surface of the first one of said any adjacent two of the plurality of light guide plates being different from a second distance between a light-entering surface and a light-emitting surface of the second one of said any adjacent two of the plurality of light guide plates.

The above arrangement indicates that (i) the illumination device includes a plurality of light guide plates which overlap one another, and that (ii) the distance between the light-entering surface and the light-emitting surface is different between adjacent light guide plates.

With the arrangement, it is possible to place each of the respective light-entering surfaces of adjacent light guide plates at any position. As such, it is possible, for instance, to use a common light source or a common light source substrate (that is, a substrate on which light sources are mounted) to emit light to such adjacent light guide plates.

As a result, according to the above arrangement, it is possible to provide an illumination device in which an increase in the number of components can be prevented.

The illumination device of the present invention may be arranged such that at least one of said any adjacent two of the plurality of light guide plates includes a guiding section which (i) includes the light-entering surface and (ii) guides the light from the light-entering surface to the light-emitting surface; and the first distance is different from the second distance due to the guiding section.

According to the above arrangement, at least one of adjacent light guide plates includes a guiding section which guides light from the light-entering surface to the light-emitting surface.

As such, it is possible to easily set the length from the light-entering surface to the light-emitting surface at any length.

As a result, it is possible to easily cause the distance from the light-entering surface to the light-emitting surface to be different between adjacent light guide plates.

In order to solve the above problems, an illumination device of the present invention includes: light sources; and a plurality of light guide plates each of which causes surface emission of light emitted from a corresponding one of the light sources, the plurality of light guide plates being arranged regularly, each of the plurality of light guide plates including: a light-emitting section having a light-emitting surface via which the surface emission of the light is caused; and a guiding section which (i) has a light-entering surface via which the light emitted from the corresponding one of the light sources enters said each of the plurality of light guide plates, and (ii) guides the light from the light-entering surface to the light-emitting surface, the plurality of light guide plates being provided so that a light-emitting section of a first one of any adjacent two of the plurality of light guide plates overlaps a guiding section of a second one of said any adjacent two of the plurality of light guide plates, a guiding section of the first one of said any adjacent two of the plurality of light guide plates being different in length from the guiding section of the second one of said any adjacent two of the plurality of light guide plates, a first distance between a light-entering surface and a light-emitting surface of the first one of said any adjacent two of the plurality of light guide plates being different, due to the difference in length, from a second distance between a light-entering surface and a light-emitting surface of the second one of said any adjacent two of the plurality of light guide plates.

According to the above arrangement, the distance from the light-entering surface to the light-emitting surface is different between adjacent light guide plates.

As such, by placing each of the respective light-entering surfaces of such adjacent light guide plates at any position as described above, it is possible to provide an illumination device in which an increase in the number of components of, for example, the light sources or light source substrates can be prevented.

Further, according to the above arrangement, each of adjacent light guide plates includes a guiding section which guides light from the light-entering surface to the light-emitting surface.

As a result, as described above, it is possible to (i) easily set the length from the light-entering surface to the light-emitting surface at any length, and (ii) easily cause the distance from the light-entering surface to the light-emitting surface to be different between adjacent light guide plates.

The illumination device of the present invention may be arranged such that the light-entering surface of any of the plurality of light guide plates is located on an identical plane due to the difference between the first distance and the second distance.

According to the above arrangement, the respective light-entering surfaces of adjacent light guide plates are located on an identical plane.

As such, it is possible to more easily use a common light source or a common light source substrate to emit light such adjacent light guide plates.

As a result, it is possible to more easily prevent an increase in the number of components.

In addition, it is also possible to (i) prevent an increase in size of the light source substrates, and consequently (ii) easily provide light sources at a high density.

The illumination device of the present invention may be arranged such that the plurality of light guide plates are aligned so that the light-emitting surface of the first one of said any adjacent two of the plurality of light guide plates does not overlap the light-emitting surface of the second one of said any adjacent two of the plurality of light guide plates.

According to the above arrangement, the respective light-emitting surfaces of adjacent light guide plates do not overlap each other. As a result, it is possible to (i) prevent an increase in thickness of the illumination device, and (ii) cause light from the light sources to be emitted reliably and efficiently.

The illumination device of the present invention may be arranged such that the plurality of light guide plates are provided so that (i) the light-emitting surface of the first one of said any adjacent two of the plurality of light guide plates and (ii) the light-emitting surface of the second one of said any adjacent two of the plurality of light guide plates are located on an identical plane.

The illumination device of the present invention may be arranged such that the light-emitting surface of each of the plurality of light guide plates is rectangular.

According to the above arrangement, since the light-emitting surfaces are rectangular, it is possible to combine a plurality of light guide plates efficiently (that is, so that (i) the light-emitting surfaces do not overlap one another and that (ii) no gap is caused between adjacent light guide plates).

The illumination device of the present invention may be arranged such that the light-emitting surface and the light-entering surface of each of the plurality of light guide plates are orthogonal to each other.

According to the above arrangement, since the light-emitting surface are orthogonal to the light-entering surface, it is possible to easily provide the light sources at positions so that the light sources are unlikely to prevent light emission.

The illumination device of the present invention may be arranged such that each of the plurality of light guide plates includes a light source container opening in which the corresponding one of the light sources is to be provided.

According to the above arrangement, since the light guide plates each have a light source container opening in which a light source is to be provided. As a result, it is possible to prevent the thickness of the illumination device from increasing due to the provision of the light sources.

The illumination device of the present invention may be arranged such that each of the plurality of light guide plates includes a plurality of the guiding section.

According to the above arrangement, each light guide plate includes a plurality of guiding sections. This indicates that each light guide plate has a plurality of light-entering surfaces. Thus, in particular, even in a case where the light guide plates each have a large light-emitting surface, it is possible to efficiently cause the light guide plates to emit light from the light sources.

As a result, it is possible to prevent in-plane brightness unevenness.

The illumination device of the present invention may be arranged such that the light-emitting section and the guiding section of each of the plurality of light guide plates are separable.

According to the above arrangement, the light-emitting section is separable from the guiding section. In other words, it is possible to prepare the light-emitting section as a member separate from the guiding section.

As such, it is possible to commonly use a member, e.g., the light-emitting section, which member has an identical structure regardless of a location at which the member is provided, in any light guide plate. As a result, it is possible to easily reduce a cost of components.

Further, by preparing, for example, the guiding section as a separate member, it is possible to easily allow, for example, a change in design of the guiding section.

A liquid crystal display device of the present invention includes, as a backlight device, any of the above illumination devices.

According to the above arrangement, since the liquid crystal display device includes any of the illumination devices, it is possible to provide a liquid crystal display device in which an increase in the number of components can be prevented.

As described above, an illumination device of the present invention is arranged such that each of a plurality of light guide plates has (i) a light-emitting surface via which surface emission of light is caused, and (ii) a light-entering surface via which light emitted from a light source enters the light guide plate, that the plurality of light guide plates are provided so that a first one of any adjacent two of the plurality of light guide plates overlaps a second one of said any adjacent two of the plurality of light guide plates, and that a first distance between a light-entering surface and a light-emitting surface of the first one of said any adjacent two of the plurality of light guide plates is different from a second distance between a light-entering surface and a light-emitting surface of the second one of said any adjacent two of the plurality of light guide plates.

As described above, an illumination device of the present invention is arranged such that each of a plurality of light guide plates includes: a light-emitting section having a light-emitting surface via which surface emission of light is caused; and a guiding section which (i) has a light-entering surface via which light emitted from a light source enters the light guide plate, and (ii) guides the light from the light-entering surface to the light-emitting surface, that the plurality of light guide plates are provided so that a light-emitting section of a first one of any adjacent two of the plurality of light guide plates overlaps a guiding section of a second one of said any adjacent two of the plurality of light guide plates, that a guiding section of the first one of said any adjacent two of the plurality of light guide plates is different in length from the guiding section of the second one of said any adjacent two of the plurality of light guide plates, and that a first distance between a light-entering surface and a light-emitting surface of the first one of said any adjacent two of the plurality of light guide plates is different, due to the difference in length, from a second distance between a light-entering surface and a light-emitting surface of the second one of said any adjacent two of the plurality of light guide plates.

As a result, it is possible to provide an illumination device in which an increase in the number of components can be prevented.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a view schematically illustrating an arrangement of a liquid crystal display device in accordance with an embodiment of the present invention.

FIG. 2 schematically illustrates an arrangement of a backlight device of an embodiment of the present invention, where (a) through (c) illustrate step by step how a plurality of light guide plates are combined with one another.

FIG. 3 is a cross-sectional view taken long line A-A of (c) of FIG. 2.

FIG. 4 schematically illustrates an arrangement of a backlight device in accordance with an embodiment of the present invention, where (a) illustrates how light guide plates are combined with one another, and (b) schematically illustrates an arrangement of an assembled light guide plate laminate unit.

FIG. 5 schematically illustrates an arrangement of a backlight device in accordance with an embodiment of the present invention, where (a) and (b) illustrate how light guide plates are combined with one another, and (c) schematically illustrates an arrangement of an assembled light guide plate laminate unit.

FIG. 6 is a cross-sectional view taken along line B-B of (c) of FIG. 5.

FIG. 7 schematically illustrates an arrangement of a backlight device in accordance with an embodiment of the present invention, where (a) illustrates how light guide plates are combined with one another, and (b) schematically illustrates an arrangement of an assembled light guide plate laminate unit.

FIG. 8 is a cross-sectional view taken along line C-C of (b) of FIG. 7.

FIG. 9 schematically illustrates an arrangement of a backlight device in accordance with an embodiment of the present invention, where (a) and (b) illustrate how light guide plates are combined with one another, and (c) schematically illustrates an arrangement of an assembled light guide plate laminate unit.

FIG. 10 is a view illustrating how a light source substrate is mounted.

FIG. 11 schematically illustrates an arrangement of a backlight device in accordance with an embodiment of the present invention, where (a) to (c) illustrate step by step how a backlight device is produced.

### DESCRIPTION OF EMBODIMENTS

An embodiment of the present invention will be described below with reference to the drawings.

The present embodiment describes an illumination device for use as a backlight device in a liquid crystal display device. The present invention is, however, not limited to this.

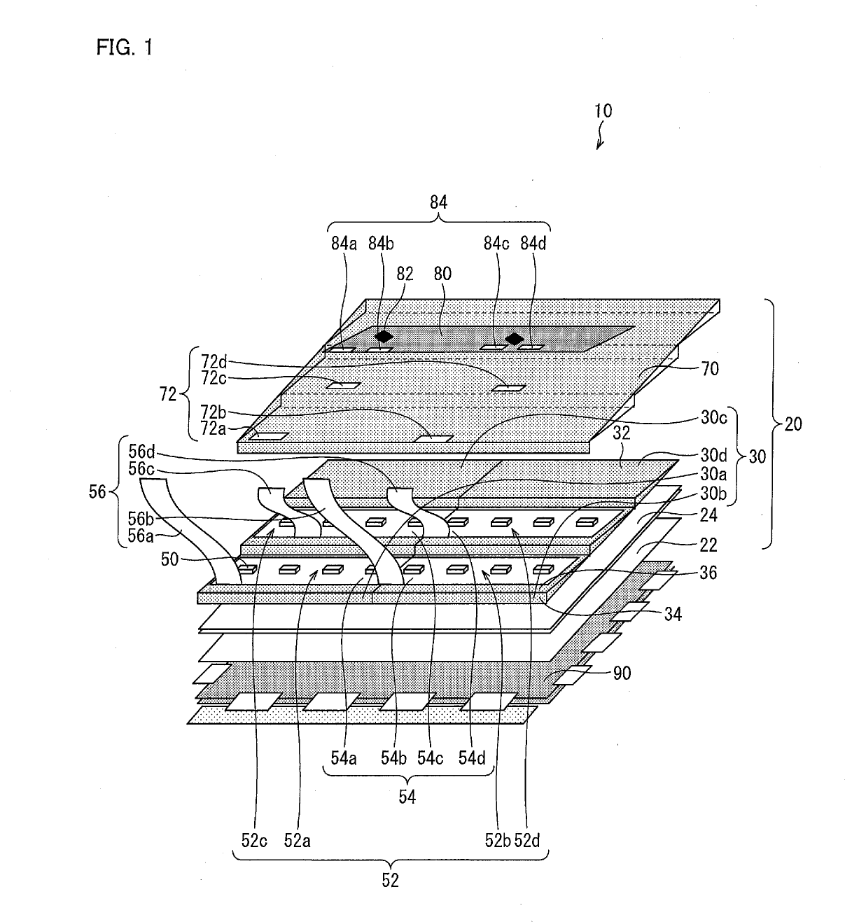

FIG. 1 is a view schematically illustrating an arrangement of a liquid crystal display device 10 according to the present embodiment.

As illustrated in FIG. 1, the liquid crystal display device 10 of the present embodiment includes: a backlight device 20 (illumination device); and a liquid crystal display panel 90 provided so as to face the backlight device 20.

(Liquid Crystal Display Panel)

The liquid crystal display panel 90 has an arrangement similar to an arrangement of a liquid crystal display panel generally used in a conventional liquid crystal display device. For example, the liquid crystal display panel 90 is configured so as to include: an active matrix substrate on which a plurality of thin film transistors (TFTs) are provided; a CF (color filter) substrate which faces the active matrix substrate; and a liquid crystal layer sealed between the active matrix substrate and the CF substrate with use of a sealing material.

Drive elements such as drivers are provided in the vicinity of edges of the liquid crystal display panel 90, and are connected to the liquid crystal display panel 90.

(Backlight Device)

The backlight device 20 is provided behind the liquid crystal display panel 90 (that is, so as to face a surface of the liquid crystal display panel 90 which surface is opposite to a display surface thereof). As illustrated in FIG. 1, the backlight device 20 includes as its main components: an optical sheet 22; a diffusing plate 24; light guide plates 30; light sources 50; a housing 70; and a light source driver substrate 80.

Note that the backlight device 20 includes at least two light guide plates 30. The following description deals with the above components one by one.

(Optical Sheet)

The optical sheet 22 will be described first. The optical sheet 22 includes various sheets in it.

The optical sheet 22 includes, for example, (i) a prism sheet which is in the shape of a prism so as to condense light, emitted via the diffusing plate 24 (described later), in a direction of the display surface of the liquid crystal display device 10, and (ii) a diffusing sheet which further diffuses light, emitted from the diffusing plate 24, so as to reduce in-plane luminance unevenness in light to be emitted from the backlight device 20.

(Diffusing Plate)

The diffusing plate 24 will be described next. The diffusing plate 24 diffuses light, emitted from each of the at least two light guide plates 30 (described later), so that a primary viewer of the liquid crystal display device 10 will less likely notice a local decrease in brightness which decrease occurs in a gap between adjacent light guide plates 30.

Specifically, in a case where the backlight device 20 includes a plurality of light guide plates 30 via which light from the light sources 50 such as LED elements is emitted, no light may be emitted from a gap region between adjacent light guide plates 30, and such a gap region may thus become darker than its surrounding region.

The diffusing plate 24, which is a light-diffusing optical member, is provided in view of the above problem so as to (i) diffuse light over an entire screen, including the above gap region, and thus (ii) achieve a light-emitting property in which a luminance difference is reduced.

An arrangement of the diffusing plate 24 is thus not particularly limited, provided that it diffuses light. The diffusing plate 24 can be formed from, for example, a resin material or a glass material.

(Light Guide Plate)

The light guide plates 30 will be described next.

The light guide plates 30 of the present embodiment include a plurality of light guide plates 30a through 30d which are combined with one another so that their respective light-emitting surfaces 32 are flush with one another. The light guide plates 30 will be described further later.

(Light Source and Light Source Substrate)

The LED elements, serving as the light sources 50, are provided on the light guide plates 30 so that light emitted from the LED elements enters the light guide plates via their respective light-entering surfaces 34.

Specifically, the LED elements are linearly mounted on LED substrates serving as light source substrates 52, each of which is a substrate on which light sources 50 are mounted.

More specifically, the light source substrates 52 each include (i) a strip-shaped section 54, which provides a region on which light sources 50 are mounted, and (ii) a connection section 56 for connecting to the light source driver substrate 80 (described later).

The LED elements are linearly provided on the strip-shaped sections 54. The strip-shaped sections 54 are mounted on bottom surfaces 36 of the respective light guide plates 30.

Note that the strip-shaped sections 54 can alternatively be mounted on the light-entering surfaces 34 of the respective light guide plates 30.

The light sources 50 are not particularly limited in kind. Thus, the light sources 50 can also be, for example, cold cathode fluorescent tubes (CCFLs) other than LED elements (light-emitting diode elements). In the present embodiment, LED elements are used as an example of the light sources 50. Further, in a case where side light-emitting type LED elements each including chips of R, G, and B molded into one package are used as the light sources 50, it is possible to produce an illumination device having a wide range of color reproduction.

Like the light guide plates 30, such details of the light sources 50 as how they are connected to a driver and how they are aligned specifically, will be described later.

(Housing)

The housing 70 (also referred to as “chassis”) will be described next. The housing 70 is sized so as to cover substantially all of back surfaces of the respective light guide plates 30. The housing 70 is also molded so as to have a shape that fits the back surfaces of the respective light guide plates 30. Specifically, the housing 70 is shaped to have protrusions formed at regular intervals which are similar to intervals of protrusions formed by the light guide plates 30 aligned. This shape of the housing is, however, not essential. Alternatively, the housing 70 can, for example, have a flat back surface.

(Light Source Driver Substrate)

The light source driver substrate 80 is provided on a back surface of the housing 70 (which surface is opposite to a surface thereof which faces the light guide plates 30). The light source driver substrate 80 is provided with members such as a driver for driving (lighting) the light sources 50.

Since the light sources 50 are LED elements in the present embodiment, the light source driver substrate 80 serves as an LED driver substrate.

Specifically, the light source driver substrate 80 is provided with, for example, a control IC, serving as a driver 82, for supplying a suitable power to the LED elements serving as the light sources 50.

The light source driver substrate 80 is further provided with connecting plugs 84 for connecting to the respective light source substrates 52. The following description deals in detail with how the light source driver substrate 80 is connected to the light source substrates 52.

(Connection Section)

As described above, the light sources 50 are mounted on the light source substrates 52. The connection between the light sources 50 and the light source driver substrate 80 is thus achieved by an electrical connection between the light source substrates 52 and the light source driver substrate 80.

Specifically, the light sources 50 are connected to the light source driver substrate 80 by an electrical connection between (i) the connection sections 56 of the respective light source substrates 52 and (ii) the connecting plugs 84 of the light source driver substrate 80.

The light source substrates 52 of the present embodiment are each formed from a flexible printed circuit board. The connection sections 56 are each provided so as to extend in a direction substantially perpendicular to a longitudinal direction of a corresponding one of the strip-shaped sections 54. The strip-shaped sections 54 are provided with wiring formed so as to connect the light sources 50 to the light source driver substrate 80.

According to the present embodiment, the strip-shaped sections 54 are separated from the light source driver substrate 80 by the housing 70 described above. The housing 70 thus has lead holes, each of which allows one of the connection sections 56 to extend through, so that the strip-shaped sections 54 are each connected to the light source driver substrate 80 at a short distance.

For example, the connection section 56a corresponding to the light guide plate 30a is led through the lead hole 72a to the back surface of the housing 70. Similarly, the connection section 56c corresponding to the light guide plate 30c is led through the lead hole 72c to the back surface of the housing 70.

The strip-shaped sections 54 are provided in multiple (namely, the strip-shaped sections 54a, 54b, 54c, and 54d) so as to correspond to the multiple light guide plates 30a, 30b, 30c, and 30d, respectively. The connection sections 56a and 54b, which are connected to the strip-shaped section 54a and 54b, respectively, are different in longitudinal length from the connection sections 56c and 54d, which are connected to the strip-shaped sections 54c and 54d, respectively.

The connection sections 56 led through the respective lead holes 72 are connected to their respective connecting plugs 84 provided on the light source driver substrate 80.

The above description deals with an arrangement in which each of the light source substrates 52 is formed in its entirety from a flexible printed circuit board so that its connection section 56 and its strip-shaped section 54 are integral with each other.

An arrangement of the light source substrates 52 is, however, not limited to this. Thus, for example, the strip-shaped sections 54 can also be formed separately from the connection sections 56.

As described above, the present embodiment, which uses LED elements as the light sources, is arranged such that (i) the LED elements (light sources 50) are linearly provided on the strip-shaped sections 54 of the respective LED substrates (light source substrates 52), and (ii) the strip-shaped sections 54 are mounted on the bottom surfaces 36 of the respective light guide plates 30.

The following description deals with the light guide plates 30 and the light sources 50 on the basis of variations.

[Variation 1: Illustration of Process of Assembling Light Guide Plate Laminate Unit-Case 1]

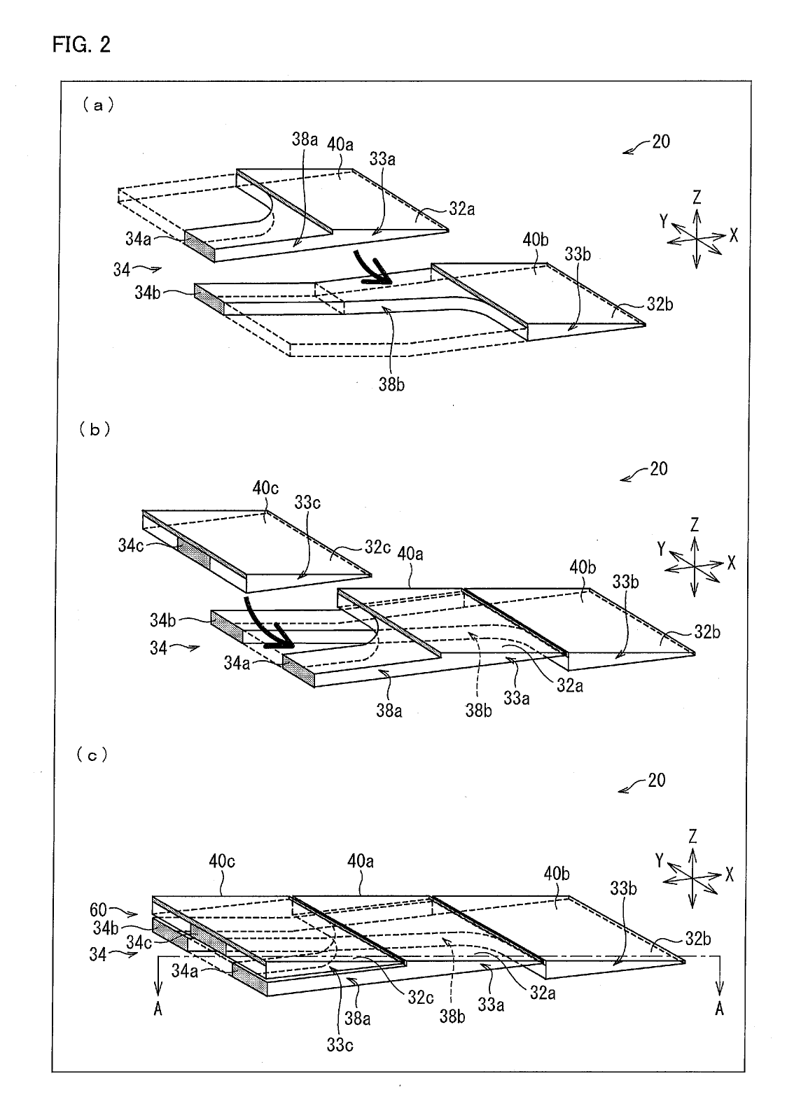

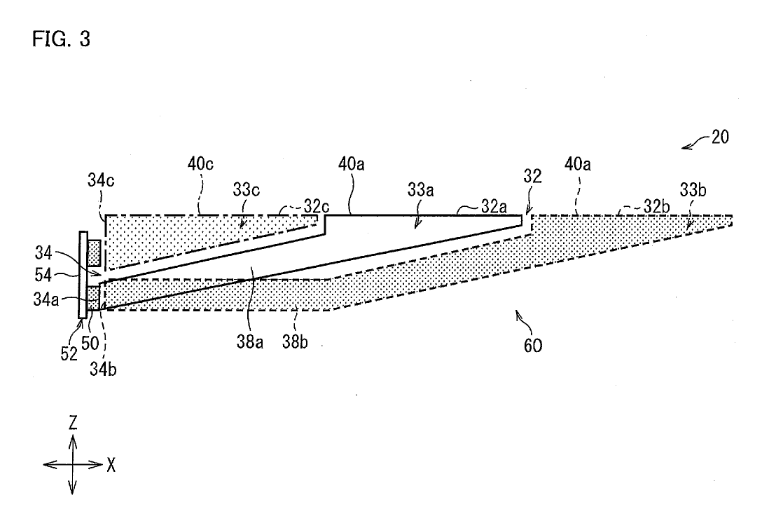

Variation 1 of the present embodiment will be described below with reference to (a) through (c) of FIG. 2 and FIG. 3.

The following description mainly deals with a light guide plate laminate unit 60 included in a backlight device 20. The light guide plate laminate unit 60 refers to a member including as its main components a plurality of light guide plates combined with one another. Such a member may further be provided with a light source substrate 52 on which light sources 50 are mounted.

(a) through (c) of FIG. 2 are each a view schematically illustrating an arrangement of a backlight device 20 of the present variation. (a) through (c) of FIG. 2 illustrate step by step how a plurality of light guide plates 40 are combined.

As illustrated in (c) of FIG. 2, according to the backlight device 20 of the present variation, three light guide plates 40 are combined so as to constitute a single light guide plate laminate unit 60. Specifically, light guide plates 40a, 40b, and 40c which are different from one another in shape are fitted with one another so that their respective rectangular light-emitting surfaces do not overlap one another. As a result, a light guide plate laminate unit 60 having a single, substantially flat light-emitting surface 32 is formed. This will be further described below.

(Light Guide Plate)

The light guide plates 40 will be described first. The light guide plates 40 of the present variation each mainly include: a light-emitting section 33 having a rectangular light-emitting surface 32; and a light-entering surface 34 via which light from a light source 50 such as an LED element enters the light guide plate 40, and may further include a guiding section 38 for guiding light from the light-entering surface 34 to the light-emitting section 33. The guiding sections 38 included in the light guide plates 40 are different from each other in distance from the light-entering surface 34 to the light-emitting section 33 (that is, to the light-emitting surface 32) depending on a location of the guiding section 38.

Specifically, as illustrated in (a) of FIG. 2, when the guiding section 38a of the first light guide plate 40a is compared with the guiding section 38b of the second light guide plate 40b, the guiding section 38b of the second light guide plate 40b is longer than the guiding section 38a of the first light guide plate 40a.

This is because a first distance between (i) the light-emitting section 33a and (ii) the light-entering surface 34a of the first light guide plate 40a is smaller than a second distance between (i) the light-emitting section 33b and (ii) the light-entering surface 34b of the second light guide plate 40b.

Note that as illustrated in (c) of FIG. 2, the third light guide plate 40c of the present variation does not include a guiding section 38. This is because the light-emitting section 33c of the third light guide plate 40c has an end surface which serves as the light-entering surface 34c. As a result, a third distance between (i) the light-entering surface 34c and (ii) the light-emitting surface 32c is shorter than the first distance for the first light guide plate 40a and the second distance for the second light guide plate 40b.

(First Light Guide Plate and Second Light Guide Plate)

As illustrated in (a) of FIG. 2, the first light guide plate 40a is fitted with the second light guide plate 40b so that the light-emitting section 33 of the first light guide plate 40a is superimposed over the guiding section 38b of the second light guide plate 40b.

Consequently, as illustrated in (b) of FIG. 2, the light-emitting surface 32a of the first light guide plate 40a and the light-emitting surface 32b of the second light guide plate 40b are adjacent to each other and thus form a single plane together.

Similarly, the light-entering surface 34a of the first light guide plate 40a and the light-entering surface 34b of the second light guide plate 40b form a single plane together. The light-entering surface 34a is, however, not adjacent to the light-entering surface 34b, and is separated from the light-entering surface 34b by a gap in a width direction of the backlight device 20 (that is, a direction indicated by an arrow Y in (b) of FIG. 2).

(Third Light Guide Plate)

With reference to (b) of FIG. 2, the following description deals with how the third light guide plate 40c is combined with a combination of the first light guide plate 40a and the second light guide plate 40b.

As illustrated in (b) of FIG. 2, the third light guide plate 40c is fitted with the combination of the first light guide plate 40a and the second light guide plate 40b so that the light-emitting section 33c of the third light guide plate 40c is superimposed over the guiding section 38a of the first light guide plate 40a and the guiding section 38b of the second light guide plate 40b.

(Light Guide Plate Laminate Unit)

With reference to (c) of FIG. 2 and FIG. 3, which is a cross-sectional view taken along line A-A of (c) of FIG. 2, the following description deals with a structure of the light guide plate laminate unit assembled as described above.

As illustrated in (c) of FIG. 2 and FIG. 3, the light-emitting surfaces 32a, 32b, and 32c of the respective light guide plates 40a, 40b, and 40c according to the present variation form a single, substantially continuous surface (that is, the light-emitting surface 32).

More specifically, the guiding section 38b of the second light guide plate 40b has a length in a light guide direction (indicated by an arrow X in (c) of FIG. 2 and FIG. 3) which length is equal to a combination of (i) a length of the light-emitting section 33a of the first light guide plate 40a in the light guide direction and (ii) a length of the light-emitting section 33c of the third light guide plate 40c in the light guide direction. Further, the guiding section 38a of the first light guide plate 40a has a length in the light guide direction which length is equal to a length of the light-emitting section 33c of the third light guide plate 40c in the light guide direction. As such, according to the present variation, (i) the light-emitting surface 32a of the first light guide plate 40a, (ii) the light-emitting surface 32b of the second light guide plate 40b, and (iii) the light-emitting surface 32c of the third light guide plate 40c together form a single plane.

The light guide plates 40a, 40b, and 40c are formed so that their respective light-emitting surfaces 32a, 32b, and 32c are orthogonal to the light-entering surfaces 34a, 34b, and 34c. With this arrangement, when the light guide plates 40a, 40b, and 40c are combined with one another so that their respective light-emitting surfaces 32a, 32b, and 32c form a single plane, the light-entering surfaces 34 are aligned in a direction perpendicular to a direction in which the light-emitting surfaces 32 are aligned.

As a result, LED elements (light sources 50) which are mounted on an LED substrate (light source substrate 52) and which transmit light to the light guide plates 40 can cause light to enter the light guide plates 40a, 40b, and 40c efficiently on the condition where the length of each of the light guide plates 40a, 40b, and 40c is short in the direction (that is, the light guide direction) in which the light-emitting surfaces 32 are aligned. Further, the light sources 50 are unlikely to prevent light emission.

According to the present variation, the third light guide plate 40c does not include a guiding section 38 as described above, and the light-entering surface 34c corresponds to an end surface of the light-emitting section 33c.

As such, as illustrated in (c) of FIG. 2 and FIG. 3, the light-entering surface 34c of the third light guide plate 40c is different from the light-entering surface 34a of the first light guide plate 40a and the light-entering surface 34b of the second light guide plate 40b in height in a thickness direction of the backlight device 20 (that is, a direction indicated by an arrow Z of FIG. 3).

The light-entering surface 34c is different from the light-entering surface 34a and the light-entering surface 34b not only in height in the thickness direction, but also in position in a longitudinal direction of the light-emitting surfaces 32 (that is, the direction indicated by the arrow Y in, for example, (c) of FIG. 2).

This is because the guiding sections are formed, in their respective light guide plates 40a and 40b, at locations different from each other in the width direction Y.

The above description states as an example that each of the light-emitting surfaces 32 is rectangular. The shape of the light-emitting surfaces 32 is, however, not limited to this. In the case where the light-emitting surfaces 32 are rectangular, it is easy to prevent, when a plurality of light guide plates are combined, (i) the light-emitting surfaces from overlapping one another and (ii) a gap from being caused.

[Variation 2: Illustration of Process of Assembling Light Guide Plate Laminate Unit-Case 2]

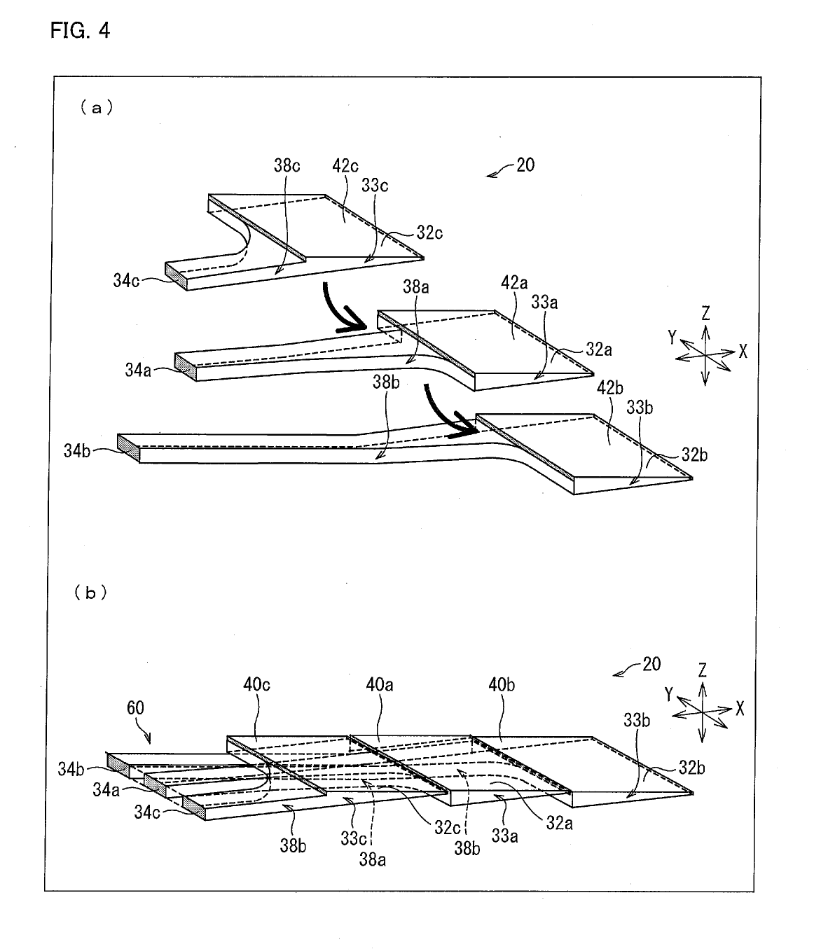

Variation 2 will be described below with reference to (a) and (b) of FIG. 4. (a) and (b) of FIG. 4 are each a view schematically illustrating an arrangement of a backlight device according to Variation 2. Specifically, (a) of FIG. 4 illustrates how light guide plates are combined, and (b) of FIG. 4 schematically illustrates an arrangement of an assembled light guide plate laminate unit 60.

As illustrated in (a) and (b) of FIG. 4, according to the backlight device 20 of Variation 2, three light guide plates 42 are combined so as to constitute a single light guide plate laminate unit 60, as in Variation 1.

Note that the backlight device 20 of Variation 2 is different from that of Variation 1 in that whereas the third light guide plate 40c of Variation 1 does not include a guiding section, a third light guide plate 42c of Variation 2 does include a guiding section 38c.

Further, since the third light guide plate 42c includes its guiding section 38c, light-entering surfaces 34a, 34b, and 34c of the respective light guides plate 42a, 42b, and 42c are, unlike in Variation 1, identically located in a thickness direction of the backlight device 20 (that is, a direction indicated by an arrow Z of, for example, (b) of FIG. 4).

As such, it is easy to downsize light source substrates to be provided on light-entering surfaces 34.

[Variation 3: Illustration of Process of Assembling Light Guide Plate Laminate Unit-Case 3]

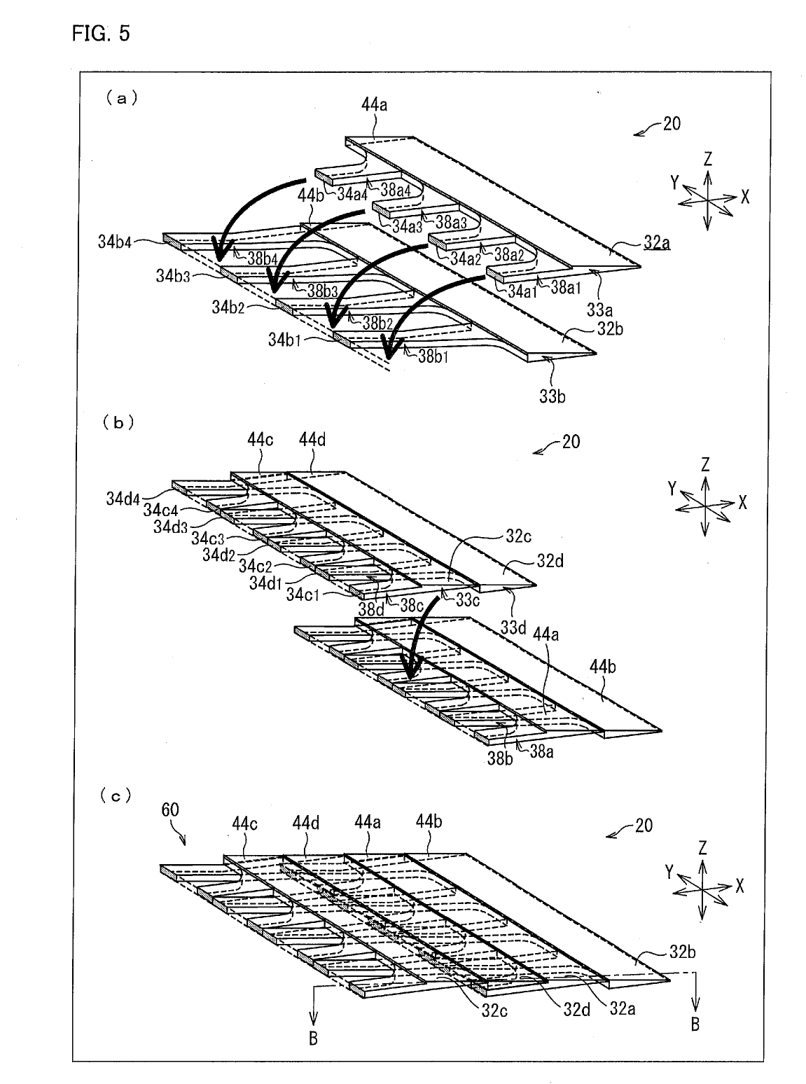

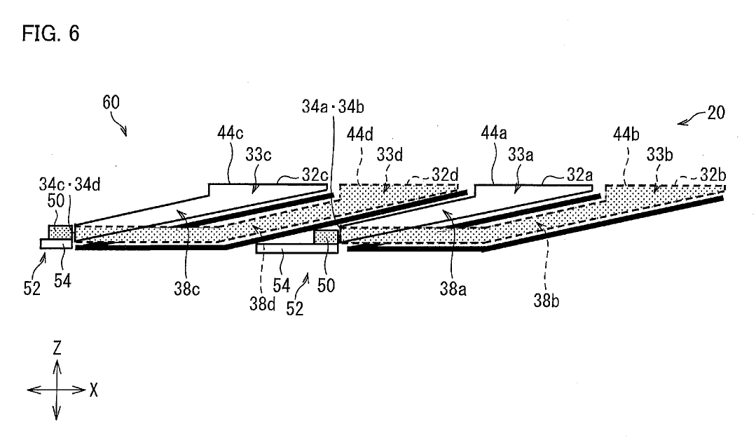

Variation 3 will be described below with reference to (a) through (c) of FIG. 5 and FIG. 6. (a) through (c) of FIG. 5 are each a view schematically illustrating an arrangement of a backlight device according to Variation 3. FIG. 6 is a cross-sectional view taken along line B-B of (c) of FIG. 5. Specifically, (a) and (b) of FIG. 5 illustrate how light guide plates are combined, and (c) of FIG. 5 schematically illustrates an arrangement of an assembled light guide plate laminate unit.

The backlight device 20 of the present variation is characteristically different from those of Variations 1 and 2 in that each light guide plate 44 of the present variation includes a plurality of guiding sections 38.

Specifically, as illustrated in (a) of FIG. 5, a first light guide plate 44a, for example, includes four guiding sections 38a1, 38a2, 38a3, and 38a4. The guiding sections 38a1, 38a2, 38a3, and 38a4 has an identical length.

In contrast, when the first light guide plate 44a is compared with a second light guide plate 44b, which is located differently from the first light guide plate 44a in the light guide plate laminate unit 60, the guiding sections 38 of the first light guide plate 44a are different in length from those of the second light guide plate 44b. Specifically, as illustrated in (a) of FIG. 5, when a length of the guiding sections 38a of the first light guide plate 44a in a light guide direction X is compared with a length of the guiding sections 38b of the second light guide plate 44b in the light guide direction X, the guiding sections 38b of the second light guide plate 44b are longer than the guiding sections 38a of the first light guide plate 44a.

More specifically, the length of the guiding sections 38b of the second light guide plate 44b is equal to a combination of (i) a length of a light-emitting section 33a of the first light guide plate 44a and (ii) the length of the guiding sections 38a of the first light guide plate 44a.

Since the length of the guiding sections 38a of the first light guide plate 44a and the length of the guiding sections 38b of the second light guide plate 44b meet the above relationship, when the first light guide plate 44a is superimposed over the guiding sections 38b of the second light guide plate 44b, light-entering surfaces 34a of the first light guide plate 44a are flush with light-entering surfaces 34b of the second light guide plate 44b.

Further, when the two light guide plates 44a and 44b are combined so that longitudinal sides of respective light-emitting surfaces 32a and 34b are adjacent to each other, the guiding sections 38a of the light guide plate 44a and the guiding sections 38b of the light guide plate 44b are alternately provided in a longitudinal direction of the light-emitting surfaces 32 (that is, a width direction Y).

This is because as in the above variations, the guiding sections are formed, in their respective light guide plates 44a and 44b, at locations different from each other in the width direction Y.

Since the alternately provided guiding sections 38 of the respective light guide plates 44 are optimized in length, the light-entering surfaces 34 of the respective light guide plates 44 are flush with each other.

Since each light guide plate 44 includes a plurality of guiding sections 38 in the present variation, each light guide plate 44 has a plurality of light-emitting surfaces 38 for the respective guiding sections 38. The first light guide plate 44a, for example, has four light-emitting surfaces 38a1, 38a2, 38a3, and 38a4.

As described above, according to the present variation, (i) each light guide plate 44 includes a plurality of guiding sections 38, and (ii) whereas the length of the guiding sections 38 is equal for each light guide plate 44, the length of the guiding sections is different between the two light guide plates 44 provided at locations different from each other.

Further, in a case where a plurality of guiding sections 38 are provided at an edge of a light-emitting surface 32 as described above, it is possible to produce a large light guide plate 44. As such, in a case where, for example, a backlight device 20 which can be used in a large screen liquid crystal module is produced, it is possible to prevent, as much as possible, an increase in number of components of a light guide plate 44. In addition, it is also possible to (i) cause light from the light sources 50 to enter the light guide plate efficiently, and (ii) prevent in-plane brightness unevenness.

Further, since the light-entering surfaces 34 of the respective light guide plates 44 are alternately provided in the width direction Y and are thus flush with each other as described above, it is possible to reduce an area for an LED substrate (light source substrate 52) on which LED elements (light sources 50) are mounted and which is provided on each light guide plate 44.

(Combination of Two Units)

With reference to (b) and (c) of FIG. 5, the following description deals with an arrangement in which an additional light guide plate 44 is further combined with the above combination of the light guide plates 44 so that an area of a complete light-emitting surface 32 is increased.

In other words, this arrangement includes another unit of two light guide plates 44 which unit is identical to the unit made up of the combination of the above two light guide plates 44 (namely, the first light guide plate 44a and the second light guide plate 44b) described above with reference to (a) of FIG. 5. Specifically, as illustrated in (b) of FIG. 5, a third light guide plate 44c is combined with a fourth light guide plate 44d in a manner identical to the manner in which the first light guide plate 44a is combined with the second light guide plate 44b. A light-emitting section 33 of the fourth light guide plate 44d is then superimposed over the guiding sections 38a of the first light guide plate 44a and the guiding sections 38b of the second light guide plate 44b.

As a result, a light guide plate laminate unit 60 in which four light guide plates (namely, the first light guide plate 44a, the second light guide plate 44b, the third light guide plate 44c, and the fourth light guide plate 44d) are integrally combined with one another is formed as illustrated in (c) of FIG. 5.

As illustrated in FIG. 6, which is a cross-sectional view taken along line B-B of (c) of FIG. 5, according to the light guide plate laminate unit 60 of the present variation, the light-emitting surfaces 32a, 32b, 32c, and 32d of the four light guide plates (namely, the first light guide plate 44a, the second light guide plate 44b, the third light guide plate 44c, and the fourth light guide plate 44d) together form a single plane and thus provide a large light-emitting surface 32.

The light-entering surfaces 34a of the first light guide plate 44a and the light-entering surfaces 34b of the second light guide plate 44b together form a single plane. Light sources 50 mounted on a light source substrate 52 are provided along the plane.

Similarly, the light-entering surfaces 34c of the third light guide plate 44c and the light-entering surfaces 34d of the fourth light guide plate 44d together form a single plane, and light sources 50 are provided along the plane.

As described above, according to the present variation, it is possible to increase the area of the light-emitting surface 32 while preventing an area for the light source substrates 52 from increasing.

[Variation 4: Illustration of Process of Assembling Light Guide Plate Laminate Unit-Case 4]

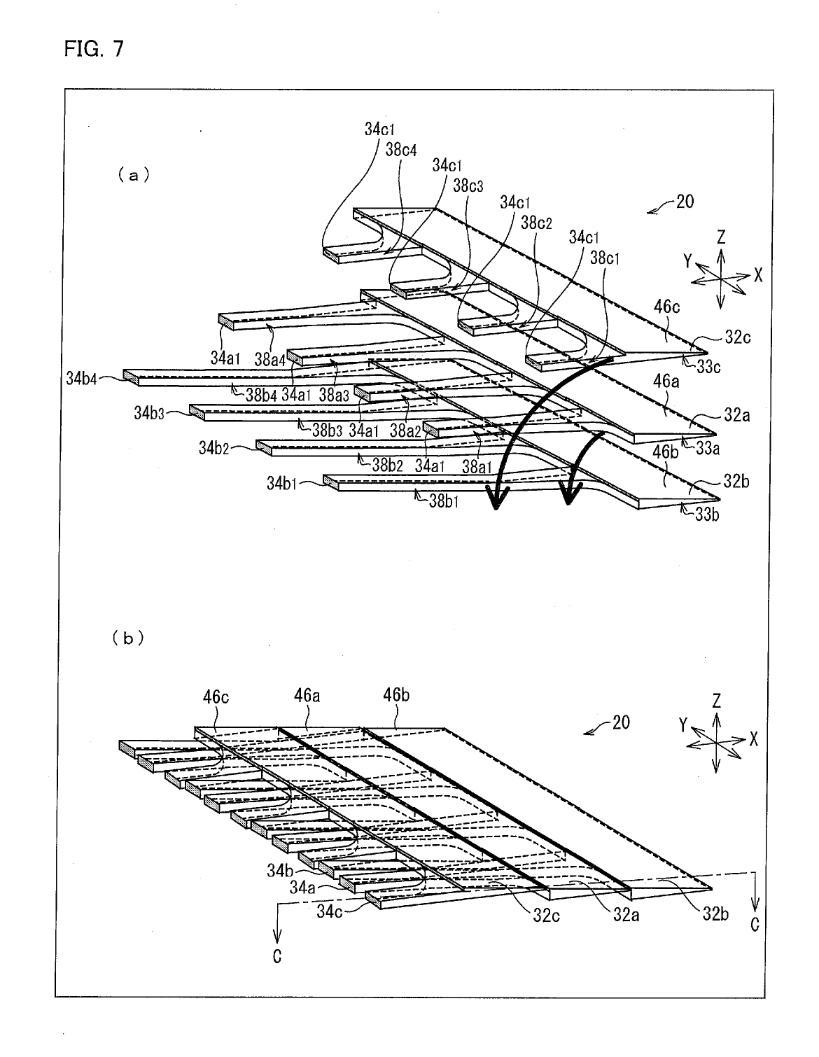

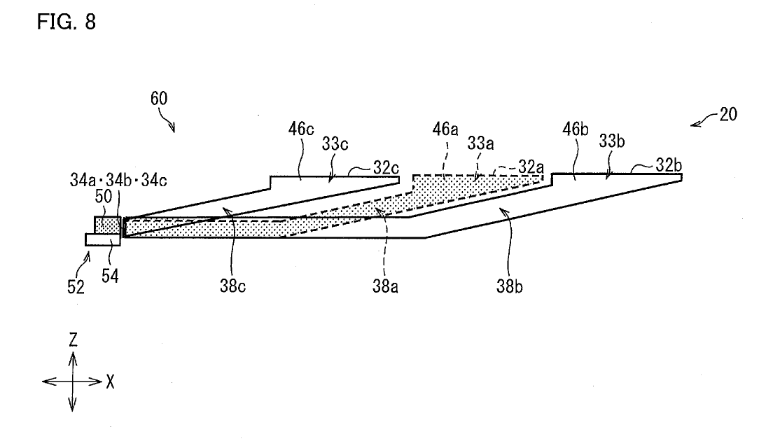

Variation 4 will be described below with reference to (a) and (b) of FIG. 7 and FIG. 8. (a) and (b) of FIG. 7 are each a view schematically illustrating an arrangement of a backlight device according to Variation 4. FIG. 8 is a cross-sectional view taken along line C-C of (b) of FIG. 7.

Specifically, (a) of FIG. 7 illustrates how light guide plates are combined, and (b) of FIG. 7 schematically illustrates an arrangement of an assembled light guide plate laminate unit.

The backlight device 20 of the present variation is similar to that of Variation 2 in that three light guide plates 46 are combined with one another so as to constitute a single light guide plate laminate unit 60. The backlight device 20 of the present variation is, however, different from that of Variation 2 in that whereas each light guide plate 42 of Variation 2 includes a single guiding section 38, each light guide plate 46 of the present variation includes a plurality of guiding sections 38. Specifically, each light guide plate 46 of the present variation includes four guiding sections 38 as in Variation 3 described above.

Further, as in Variation 3, the guiding sections 38 are different among the three light guide plates 46 (i) in length in the X direction and (ii) in position in the width direction Y.

As such, it is possible, as in Variation 2, to (i) use a single light source substrate 52 to cause light to enter three light guide plates 46, and (ii) easily produce a large light guide plate 46 while preventing an increase in the number of components.

When a length of a light guide plate 46 in the width direction Y is compared with a sum of lengths of the respective four guiding sections 38 of the light guide plate 46 in the width direction Y, the sum of the lengths of the respective guiding sections 38 is shorter. As such, according to the light guide plates 46 of the present variation, it is possible to cause light to enter a light guide plate 46 through regions each of which is less wide than a main portion of the light guide plate 46.

Further, as illustrated in (b) of FIG. 7, according to the present variation, a sum of lengths of light-entering surfaces 34 of the three light guide plates 46 in the width direction Y is substantially equal to the length of the light guide plates 46 in the width direction Y. In other words, the sum of the lengths of the light-entering surfaces 34 in the width direction falls within a range of the width of the light guide plates 46.

This indicates that a light source substrate 52 provided for a unit of light guide plates 46 is less likely to be shifted in the width direction beyond the light guide plates 46. As such, it is possible to combine a plurality of light guide plate laminate units efficiently.

Since the light-emitting surfaces 32 are aligned as illustrated in (b) of FIG. 7 as described above, the light-entering surfaces 34 are aligned in a longitudinal direction of the light-emitting surfaces 32 (that is, the width direction Y). Thus, LED elements which are mounted on an LED substrate and which transmit light to light guide plates 46 can cause light to enter the light guide plates 46 efficiently on the condition where the light guide plates 46 are short in length in a direction in which the light-emitting surfaces 32 are aligned.

As illustrated in FIG. 8, which is a cross-sectional view taken along line C-C of (b) of FIG. 7, one light source substrate 52 is provided for each light guide plate laminate unit 60 in which three light guide plates 46 are combined. Further, as illustrated in FIG. 8, the light-entering surfaces 34 of the three light guide plates 46 are provided at an identical height (location) in the thickness direction Z of the backlight device 20. As such, according to the present variation, it is possible to downsize light source substrates 52.

(Example of Mounting Backlight Device in Liquid Crystal Display Device)

With reference to drawings, the following description exemplifies how the backlight device 20 of the present embodiment is mounted in a liquid crystal display device.

The example below describes a manner in which a light source substrate 52 is provided with respect to light-entering surfaces 34, which manner is different from those described in the above variations.

Note that the manner of the present invention in which manner a light source substrate 52 is provided is not limited to those described in the above variations and a manner described below. The manner of the present invention can thus be altered variously.

(Light Source Container Opening)

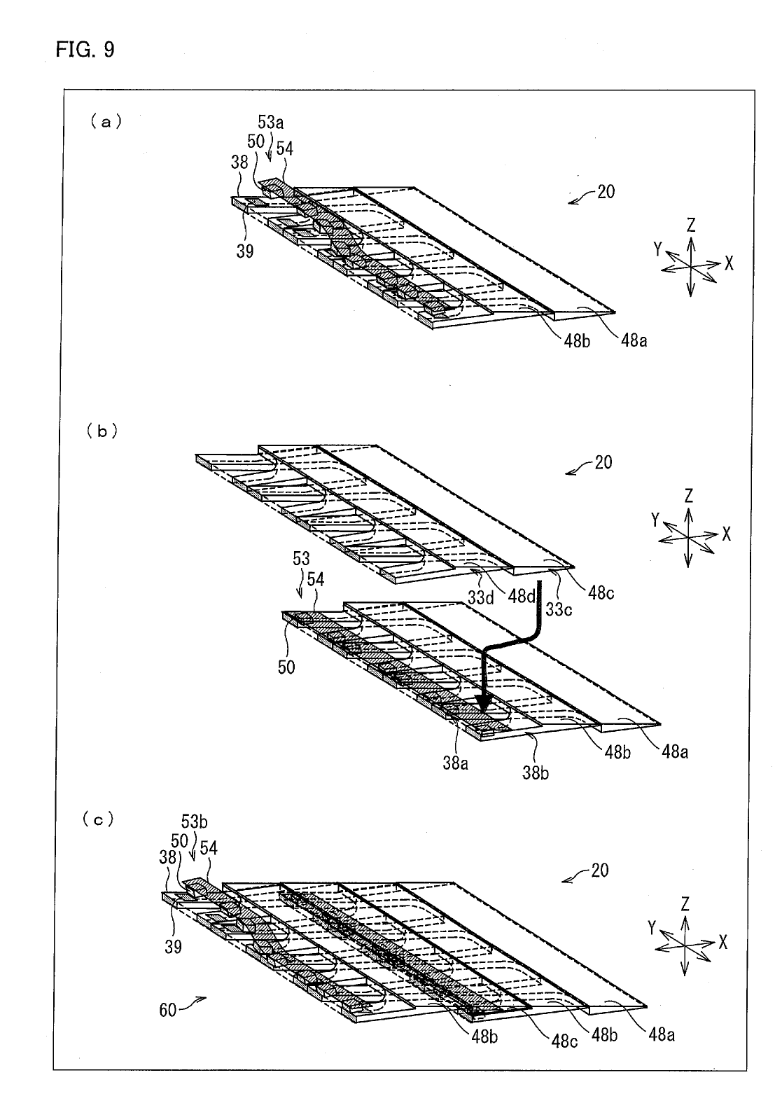

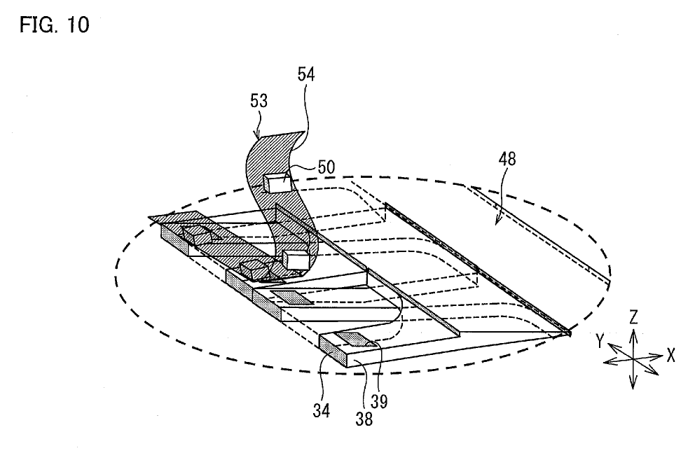

With reference to (a) through (c) of FIG. 9 and FIG. 10, the following description deals with how light source substrates 52 are provided by use of light source container openings. (a) through (c) of FIG. 9 are each a view illustrating how light guide plates 48 are combined so as to constitute a light guide plate laminate unit 60. FIG. 10 is a view illustrating how a light source substrate is mounted with use of light source container openings 39.

The above variations describe, for example, (i) a case in which an LED substrate serving as a light source substrate 52 is provided along light-entering surfaces 34 of light guide plates, and (ii) a case in which an LED substrate is provided below guiding sections 38 of light guide plates.

Depending on a thickness of a light source substrate 52 to be used, the light source substrate 52 can be provided at a location, other than the locations described above, between adjacent light guide plates, that is, the light source substrate 52 can be sandwiched between guiding sections of one light guide plate and a light-emitting section of another light guide plate.

In a case where such an arrangement is employed, the guiding sections 38 of each light guide plate can have their respective light source container openings 39, that is, openings in each of which a light source 50 is to be contained.

Specifically, the light source container openings 39 are each an opening which is formed at a location in a guiding section 38, close to the light-entering surface 34 thereof, and which has a shape substantially identical to a shape of a light source 50 (see FIG. 10). Since the light sources 50 are cuboid in the present example, the light source container openings 39 are cuboid as well so that the light sources 50 can fit therein.

Further, in the present example, a light source substrate 53 is provided to the guiding sections 38 of each light guide plate 48 so that light sources 50 mounted on a strip-shaped section 54 of the light source substrate 53 fit in respective light source container openings 39.

The light source substrates 53 of the present example are each formed from a PFC board (flexible printed circuit board).

With reference to drawings such as (a) of FIG. 9, the following description deals with how a light guide plate laminate unit 60 is assembled.

First, as illustrated in (a) of FIG. 9, a first light guide plate 48a is combined with a second light guide plate 48b as in Variation 3.

Next, as illustrated in FIG. 10 in detail, a light source substrate 53a is provided on the first light guide plate 48a and the second light guide plate 48b so that light sources on the light source substrate 53a fit in respective light source container openings 39. In other words, an FPC board on which LED elements are mounted is provided on upper surfaces of respective guiding sections 38.

Then, as illustrated in (b) of FIG. 9, a third light guide plate 48c is combined with a fourth light guide plate 48d in a manner identical to the manner in which the first light guide plate 48a is combined with the second light guide plate 48b.

After that, as in Variation 3, the combination of the third light guide plate 48c and the fourth light guide plate 48d is stacked on the combination of the first light guide plate 48a and the second light guide plate 48b so that a light-emitting section 33c of the third light guide plate 48c is superimposed over the guiding sections 38a of the first light guide plate 48a and the guiding sections 38b of the second light guide plate 48b.

As a result, a light guide plate laminate unit 60 in which the four light guide plates 48a, 48b, 48c, and 48d are combined with one another is formed as illustrated in (c) of FIG. 9.

Next, a light source substrate 53b is further provided on the third light guide plate 48c and the fourth light guide plate 48d in a manner identical to the manner in which the light source substrate 53a is placed on the first light guide plate 48a and the second light guide plate 48b.

As described above, (i) an LED substrate serving as a light source substrate 53 is provided on the guiding sections 38 of each light guide plate 48, and (ii) the light-emitting section 33 of another light guide plate 48 is then stacked on the guiding sections. By repeating (i) and (ii) above, it is possible to integrally combine a plurality of light guide plates 48 with an LED substrate, which can cause each of the plurality of light guide plates 48 to emit light and which has a small mount area.

As such, the backlight device 20 of the present invention can prevent a liquid crystal display panel from having a large thickness even in a case where the liquid crystal display panel has a large screen.

Note that the shape of the light source container openings 39 is not limited to the above shape. For example, the light source container openings can be holes penetrating through the respective guiding sections 38 of each light guide plate 48 in its thickness direction Z. The light source container openings can alternatively be depressions having any shape.

(Containing Light Guide Plate Laminate Units in Plate-Shaped Container)

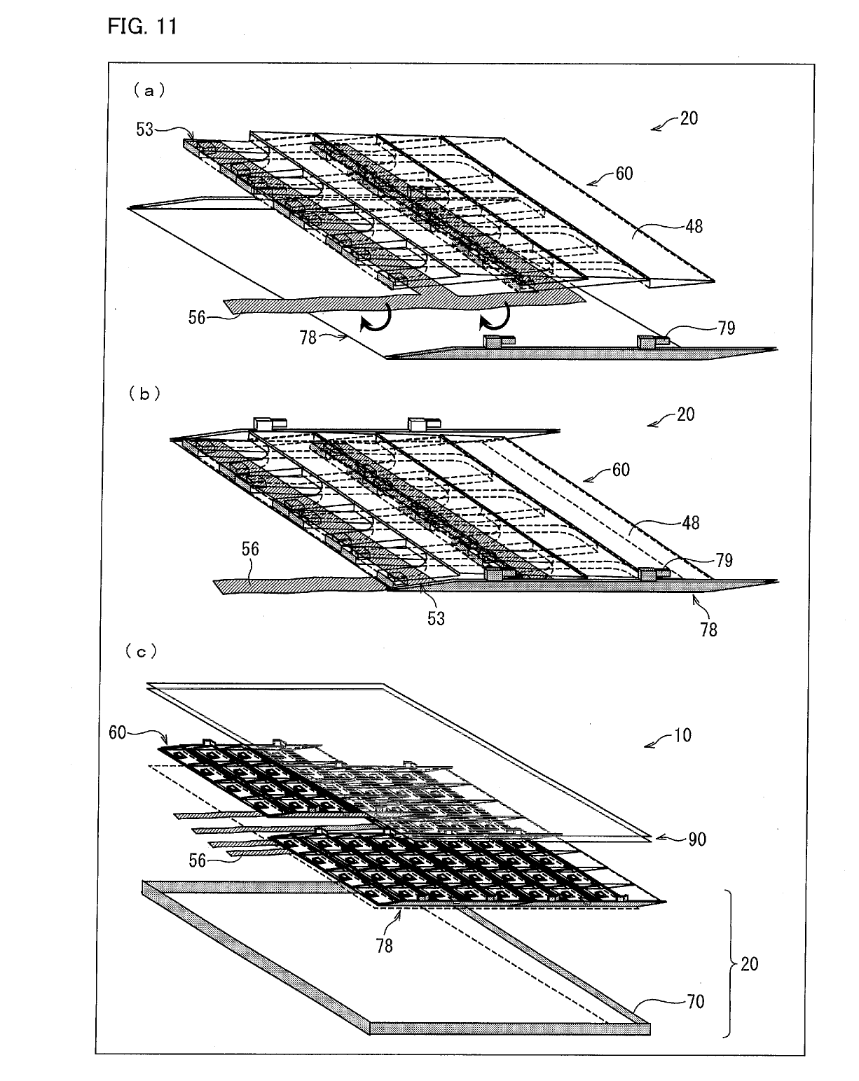

With reference to (a) through (c) of FIG. 11, the following description deals with how the light guide plate laminate unit 60 illustrated in (c) of FIG. 9 is contained in a plate-shaped container 78.

The plate-shaped container 78 is, for example, a plate-shaped body, such as a processed aluminum plate (approximately 0.5 mm in thickness), to which a reflecting sheet is attached. The plate-shaped container 78 supports a combination of a plurality of light guide plates 48 from their back surfaces. Further, the plate-shaped container 78 includes protrusions (protruding sections 79) processed so as to be bendable.

As illustrated in (a) and (b) of FIG. 11, a plurality of light guide plate laminate units 60 are combined with one another in columns, and are thus contained in the plate-shaped container 78. The plate-shaped container 78 of the present example is a plate-shaped aluminum container with two opposite edges bent toward a front side of the plate-shaped container.

When the light guide plate laminate units 60 are contained in the plate-shaped container 78, the connection sections 56 of the respective light source substrates 53 are bent and led through the plate-shaped container 78 to the outside.

After the light guide plate laminate units 60 are thus contained, the protruding sections 79 of the plate-shaped container 78 are bent.

In a case where the protruding sections 79 are bent as above, the light guide plate laminate units 60 are fixed in position in the plate-shaped container 78.

The protruding sections 79 further serve as spacers for maintaining a predetermined gap (which falls within a range from approximately 1 to approximately 3 mm) between (i) the light guide plate laminate units 60 and (ii) members such as a diffusing plate (not shown) provided above upper surfaces of the respective light guide plate laminate units 60.

As illustrated in (c) of FIG. 11, the light guide plate laminate units 60 integrally contained in the plate-shaped container 78 are combined with a housing 70 so as to constitute a backlight device 20.

The backlight device 20 is then combined with a liquid crystal display panel 90 so as to constitute a liquid crystal display device 10.

The present invention is not limited to the description of the embodiments above, but may be altered in various ways by a skilled person within the scope of the claims. Any embodiment based on a combination of technical means altered within the scope of the claims is also encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided that such variations do not exceed the scope of the patent claims set forth below.

### INDUSTRIAL APPLICABILITY

The illumination device of the present invention can prevent an increase in the number of components. The illumination device can thus be suitably used for an application which requires lighting for a large area.

### REFERENCE SIGNS LIST

10 liquid crystal display device
20 backlight device (illumination device)
30 light guide plate
32 light-emitting surface
33 light-emitting section
34 light-entering surface
38 guiding section
39 light source container opening
40 light guide plate
42 light guide plate
44 light guide plate
46 light guide plate
48 light guide plate
50 light source

1. An illumination device, comprising:
light sources; and
a plurality of light guide plates each of which causes surface emission of light emitted from a corresponding one of the light sources,
the plurality of light guide plates being regularly provided,
each of the plurality of light guide plates having (i) a light-emitting surface via which the surface emission of the light is caused, and (ii) a light-entering surface via which the light emitted from the corresponding one of the light sources enters said each of the plurality of light guide plates,
the plurality of light guide plates being provided so that a first one of any adjacent two of the plurality of light guide plates overlaps a second one of said any adjacent two of the plurality of light guide plates,
a first distance between a light-entering surface and a light-emitting surface of the first one of said any adjacent two of the plurality of light guide plates being different from a second distance between a light-entering surface and a light-emitting surface of the second one of said any adjacent two of the plurality of light guide plates.

2. The illumination device according to claim 1, wherein:
at least one of said any adjacent two of the plurality of light guide plates includes a guiding section which (i) includes the light-entering surface and (ii) guides the light from the light-entering surface to the light-emitting surface; and
the first distance is different from the second distance due to the guiding section.

3. An illumination device, comprising:
light sources; and
a plurality of light guide plates each of which causes surface emission of light emitted from a corresponding one of the light sources,
the plurality of light guide plates being arranged regularly,
each of the plurality of light guide plates including:
a light-emitting section having a light-emitting surface via which the surface emission of the light is caused; and
a guiding section which (i) has a light-entering surface via which the light emitted from the corresponding one of the light sources enters said each of the plurality of light guide plates, and (ii) guides the light from the light-entering surface to the light-emitting surface,
the plurality of light guide plates being provided so that a light-emitting section of a first one of any adjacent two of the plurality of light guide plates overlaps a guiding section of a second one of said any adjacent two of the plurality of light guide plates,
a guiding section of the first one of said any adjacent two of the plurality of light guide plates being different in length from the guiding section of the second one of said any adjacent two of the plurality of light guide plates,
a first distance between a light-entering surface and a light-emitting surface of the first one of said any adjacent two of the plurality of light guide plates being different, due to the difference in length, from a second distance between a light-entering surface and a light-emitting surface of the second one of said any adjacent two of the plurality of light guide plates.

4. The illumination device according to claim 1, wherein:
the light-entering surface of any of the plurality of light guide plates is located on an identical plane due to the difference between the first distance and the second distance.

5. The illumination device according to claim 1, wherein:
the plurality of light guide plates are aligned so that the light-emitting surface of the first one of said any adjacent two of the plurality of light guide plates does not overlap the light-emitting surface of the second one of said any adjacent two of the plurality of light guide plates.

6. The illumination device according to claim 1, wherein:
the plurality of light guide plates are provided so that (i) the light-emitting surface of the first one of said any adjacent two of the plurality of light guide plates and (ii) the light-emitting surface of the second one of said any adjacent two of the plurality of light guide plates are located on an identical plane.

7. The illumination device according to claim 1, wherein;
the light-emitting surface of each of the plurality of light guide plates is rectangular.

8. The illumination device according to claim 1, wherein:
the light-emitting surface and the light-entering surface of each of the plurality of light guide plates are orthogonal to each other.

9. The illumination device according to claim 1, wherein:
each of the plurality of light guide plates includes a light source container opening in which the corresponding one of the light sources is to be provided.

10. The illumination device according to claim 2,
wherein:
each of the plurality of light guide plates includes a plurality of the guiding section.

11. The illumination device according to claim 3,
wherein:
the light-emitting section and the guiding section of each of the plurality of light guide plates are separable.

12. A liquid crystal display device comprising, as a backlight device, an illumination device recited in claim 1.
